(19) United States
(12) Patent Application Publication
(10) Pub. No.: US 2016/0147969 A1
(43) Pub. Date: May 26, 2016

(54) TOTAL HEALTH SERVICES PROVIDER

(71) Applicant: TOTAL WELLNESS CLINIC, TAIPEI CITY 105 (TW)

(72) Inventor: CHEN CHEE LIN, TAIPEI CITY 105 (TW)

(21) Appl. No.: 14/548,458

(22) Filed: Nov. 20, 2014

(51) Int. Cl. G06F 19/00

(52) U.S. Cl. CPC G06F 19/3418; G06F 19/322; G06F 19/3487

(57) ABSTRACT

A professional total health services provider and leader specialized in integrative medicine incorporating data collection tools, analysis tools, and health adjustment procedures. The data collection tools first detect, extract, monitor, and/or receive data from the patient. This data is then provided to the analysis tools according to various integrated medicine methods, from which patient reports with visual diagrams are created and shared with the patient. Each patient's data and relative analysis are individually saved in the respective patient's records and, as a whole, anonymously stored in a database. The anonymous data in this database undergoes comprehensive analysis, utilizing master analysis tools, where the results are employed to produce reliable study reports. Medical facility franchises under the provider send the collected patient data to a central facility for extensive analysis and reporting, after which the appropriate health adjustment procedures are then suggested to and performed on each patient.

### BACKGROUND OF THE INVENTION

1. Field of the Invention

The present invention relates to medical services. More specifically, the present invention discloses a system and method for providing an expandable total health services provider network utilizing integrated medicine to prevent disease and promote health.

2. Description of the Prior Art

Conventional medical facilities such as hospitals provide services based on disease-based medicine. However, only treating a disease fails to promote health. Additionally, disease-based treatment requires conventional medical facilities to provide medical services in a departmentalized manner.

For example, if a patient complains of lower abdomen pain, the patient is sent to the gastrointestinal department for testing. Not only are the results of the testing typically kept within the department and the patient's record but are also known to a few medical professionals within the department. As a result, other medical departments are not consulted on health conditions that may have influence on the patient's lower abdomen pain. This lowers the effectiveness of treatment and can negatively affect the patient's recovery.

Also, medical professionals in conventional facilities tend to have uneven quality concepts, service ideas, attitudes, education, and level of sophistication. Additionally, there are a wide variety of tools, instruments, health foods, techniques, treatments, that need to be known. In order to remove the departmentalized structure of the conventional medical facility would incur extremely high training costs.

Furthermore, conventional disease-based medical professionals are not open to consulting other types of medicine such as complementary alternative medicine (CAM), functional medicine, or natural medicine. As a result, the optimal promotion of health cannot be achieved.

Moreover, the costs associated with establishing a new conventional medical facility are exorbitant and prevents the effective promotion of health for all people, especially in rural areas.

Therefore, there is need for an efficient system and method for providing total health services to as many people as possible by efficiently expanding medical facilities.

### SUMMARY OF THE INVENTION

To achieve these and other advantages and in order to overcome the disadvantages of the conventional method in accordance with the purpose of the invention as embodied and broadly described herein, the present invention provides a total health services system and method that is easily expandable to promote health to a growing number of people in a cost effective manner.

The total health services provider utilizes integrated medicine to prevent disease and promote health. The present invention does not test for only a positive or negative result but rather builds a complete array of a patient's health. Revisits to the total health services provider effectively shows the improvement in the patient's health.

The total health services provider system and method of the present invention comprises at least one medical facility such as, for example, a clinic. The medical facility comprises a plurality of data collection tools, a plurality of analysis tools, and a plurality of health adjustment procedures. The data collection tools comprise instruments, implements, devices, or other tools that extract, detect, monitor, or receive data from a patient. This data comprises, for example, heart rate, iris data, blood, blood data, acupressure data, meridian data, and spinal structure.

The patient data from the data tools are provided to the analysis tools for analyzing. The analyzing tools analyze the patient data according to various methods or techniques to achieve analysis results. The analyzing tools perform analysis of, for example, blood, nutritional biochemistry, metabolism, gastrointestinal, parasite, hormone, immune system, heavy metal, hypertension, cholesterol, etc.

Patient reports are created from the analysis data and appropriate patient reports are provided to patients for their reference and to better understand their health status.

After analysis, health adjustment procedures are performed with the patient. Such health adjustment procedures effectively improve the physical root of the problem and promote the patient's health. The health adjustment of the present invention comprises, for example, nutritional adjustment, weight nutrition, diet adjustment, chiropractic adjustment, exercise, aromatherapy, music therapy, and other methods to provide assistance in the conditioning and promotion of a patients health.

The patient data and the analysis data are stored in a patient database that is readily accessible to authorized medical personnel at any time. The identity of the patient is removed from the patient data and analysis data and stored in a total patient database. The data from a plurality of patients stored in the total patient database is analyzed. Since each of the plurality of patients has a different health status but some have similar conditions or data points, analysis results of the total data can provide useful information to medical professionals.

Results from the total analysis tools are utilized to provide study data reports that can be shared with medical professionals within the total health services provider network and with others that have not yet joined the total health services provider network. The total health services provider comprises far more than just a health data storage and processing center but also comprises effective health adjustment processes and methods to improve the health of patients.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification.

The drawings illustrate embodiments of the invention and, together with the description, serve to explain the principles of the invention. In the drawings:

FIG. 1 is drawing illustrating components and interactions of a total health services provider according to an embodiment of the present invention;

FIG. 2 is a flowchart illustrating a method for providing total health services according to an embodiment of the present invention;

FIG. 3 is a drawing illustrating an example of a patient report according to an embodiment of the present invention;

FIG. 4 is a drawing illustrating the integrated medicine philosophy utilized by the total health services provider according to an embodiment of the present invention;

FIG. 5 is a drawing illustrating data tools and analysis tools according to an embodiment of the present invention;

FIG. 6 is a drawing illustrating an expandable total health services provider according to an embodiment of the present invention; and

FIG. 7 is a drawing illustrating a total health services provider facility according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

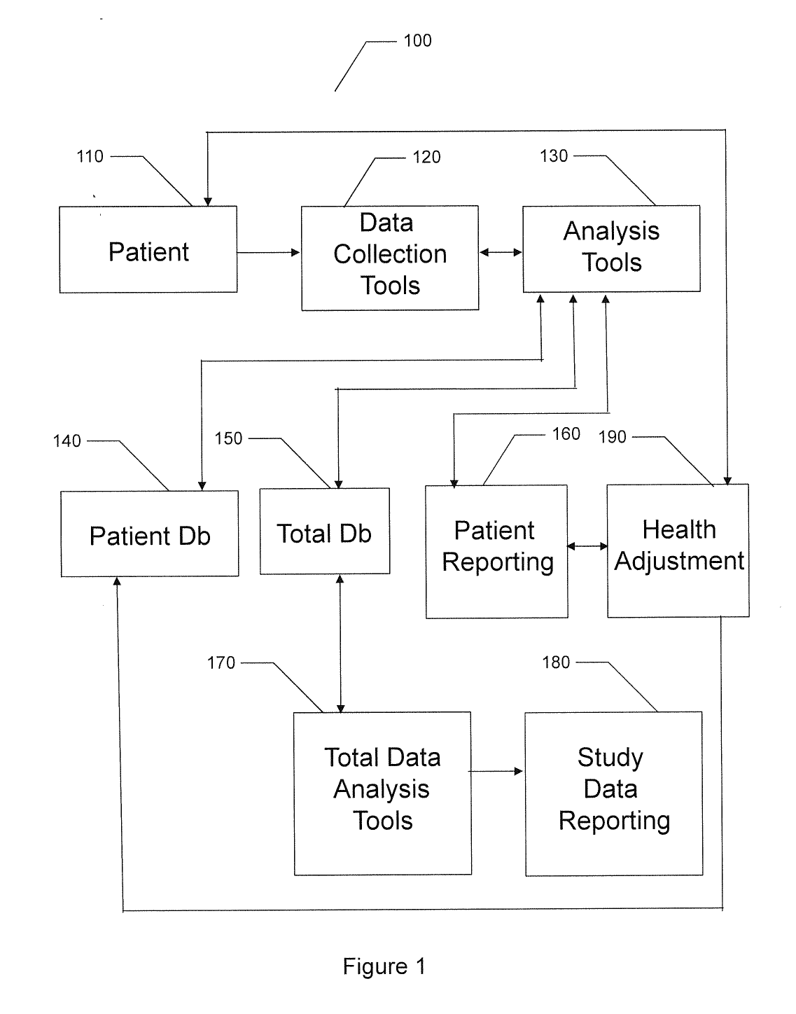

Refer to FIG. 1. In the embodiment illustrated in FIG. 1 the total health services provider system 100 comprises a plurality of integrated medicine data collection tools 120 and a plurality of integrated medicine analysis tools 130.

The data collection tools 120 comprise instruments, implements, devices, or other tools that extract, detect, monitor, or receive data from a patient 110. This data comprises, for example, heart rate, iris data, blood, blood data, meridian point data, acupressure data, or 3-dimensional bio-energy/bio-information magnetic resonance imaging and functional body analysis (3D MRA).

The patient data from the data collection tools 120 are provided to the analysis tools 130 for analyzing. The analyzing tools 130 analyze the patient data according to various methods or techniques to achieve analysis results. The analyzing tools 130 perform analysis of for example, blood, nutritional biochemistry, metabolism, gastrointestinal, parasite, hormone, immune system, heavy metal, hypertension, cholesterol, etc.

Patient reports 160 are created from the analysis data and appropriate patient reports are provided to patients 110 for their reference and to better understand their health status.

The total health services provider system 100 further comprises a plurality of health adjustment procedures 190.

After analysis of the patient data, the appropriate health adjustment procedures 190 are selected and performed with the patient 110. Such health adjustment procedures effectively improve the physical root of the problem and promote the patient's health. The health adjustment procedures 190 of the present invention comprise, for example, nutritional adjustment, weight nutrition, diet adjustment, chiropractic adjustment, exercise, aromatherapy, music therapy, recreation therapy, hypnosis, yoga, detoxification, flower essence, thermo-therapy, hydro-therapy, 3D MRA, and other methods to provide assistance in the conditioning and promotion of a patients health.

The health adjustment procedures 190 that are performed with the patient and associated data with the procedures are stored in the patient database 140 and also anonymously stored in the total database 150. The suggested health adjustment procedures 190 are displayed in the patient reports for the patient's and health professional's reference and consideration.

The patient data and the analysis data are stored in a patient database 140 for each individual patient and the data is readily accessible to authorized medical personnel at any time. The identity of the patient 110 is removed from the patient data and analysis data and stored in a total patient database 150. The data from a plurality of patients stored in the total patient database 150 is analyzed by total data analysis tools 170. Since each of the plurality of patients has a different health status but some have similar conditions or data points, analysis results of the total data can provide useful information to medical professionals.

Results from the total data analysis tools 170 are utilized to provide study data reports 180 that can be shared with medical professionals within the total health services provider network and with others that have not yet joined the total health services provider network.

The patient database 140 and the total patient database 150 are stored on a server comprising a microprocessor and a non-transitory memory.

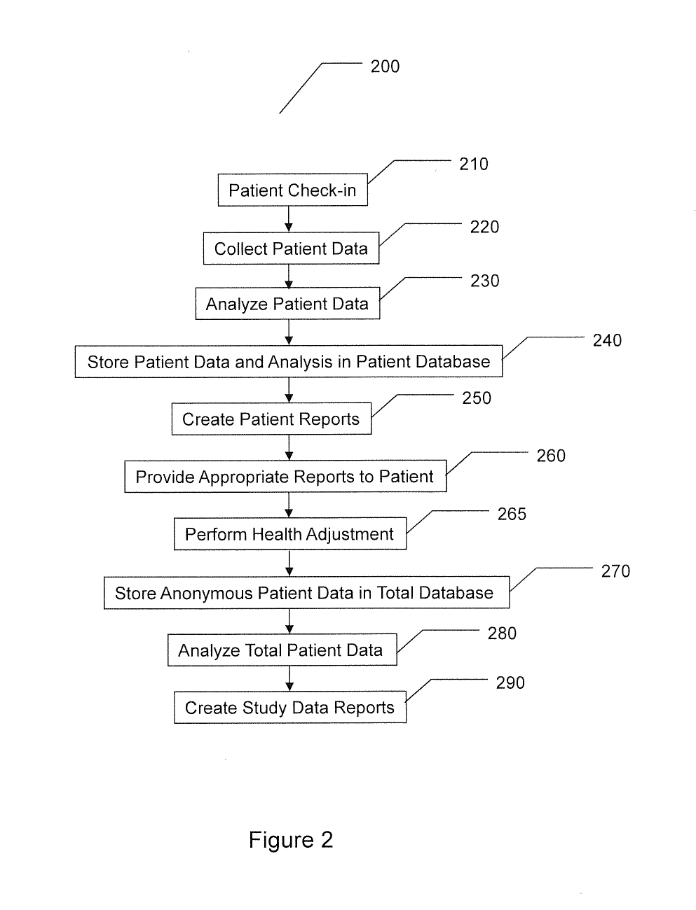

Refer to FIG. 2. In the embodiment illustrated in FIG. 2 the method for providing total health services 200 comprises checking in a patient when the patient arrives at the medical facility in Step 210. If this is the patient's first visit to the medical facility, the patient's information is obtained and the patient is registered as a client in Step 210.

In Step 220 a medical professional utilizes a data collection tool to obtain data from the patient. The obtained patient data is provided to the analysis tools and the patient data is analyzed by the analysis tools in Step 230. The obtained patient data and the results of the analysis by the analysis tools are stored in a patient database that is unique for each individual patient in Step 240.

In Step 250 patient reports are created from the patient data and/or the analysis results. Appropriate reports are provided to the patient in Step 260.

The analysis results and patient reports are use to select appropriate health adjustment procedures and the appropriate health adjustment procedures are performed with the patient in Step 265.

The identity of the patient is removed from the patient data and replaced with an anonymous identifier so that the data can be identified without invading the privacy of the patient. In Step 270 the anonymous patient data in stored in a total patient database. This total patient data is analyzed by the total data analysis tools in Step 280. In Step 290 patient study data reports are created from the total patient data and the total data analysis results.

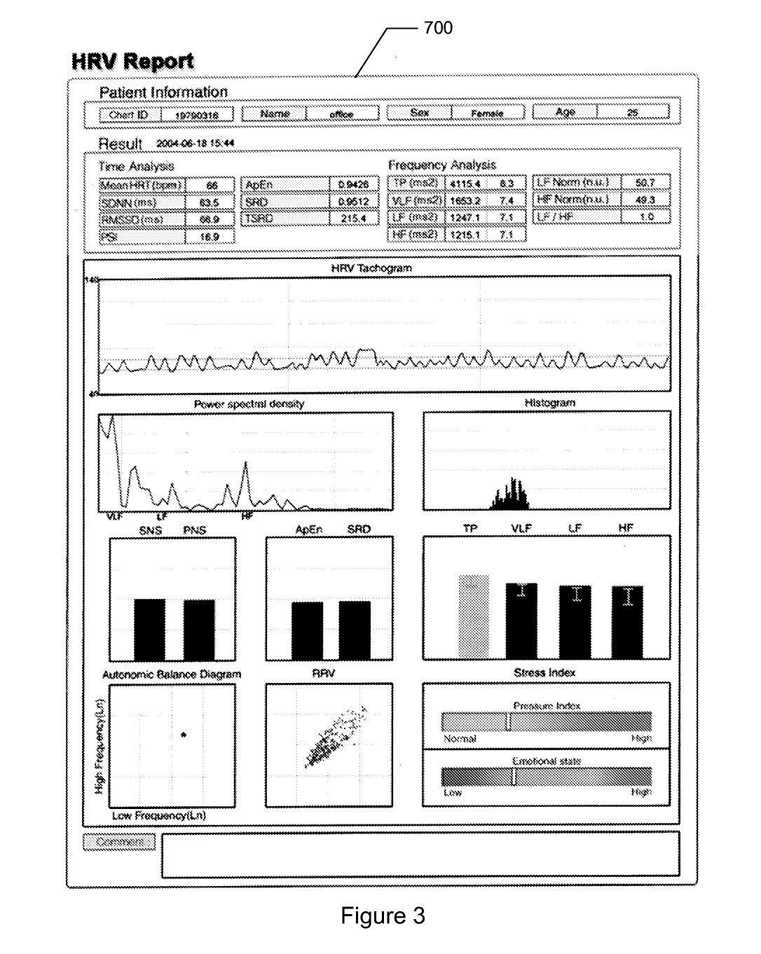

Refer to FIG. 3 which illustrates an example of a patient report 700. The patient report provides patient data and analysis results displayed as text and as visual diagrams. The visual diagrams allow a patient to more easily understand their condition rather than just reading numbers. The clarity of the data encourages the patient to take an active role in improving their health. Also, the patient can easily compare their patient reports to see the improvement of their health.

The patient report 700 further comprises graphical depictions showing a patient's history for efficient reference to illustrate the improvement in a patient's health. This allows the patient and health professional to easily see the patient's progress.

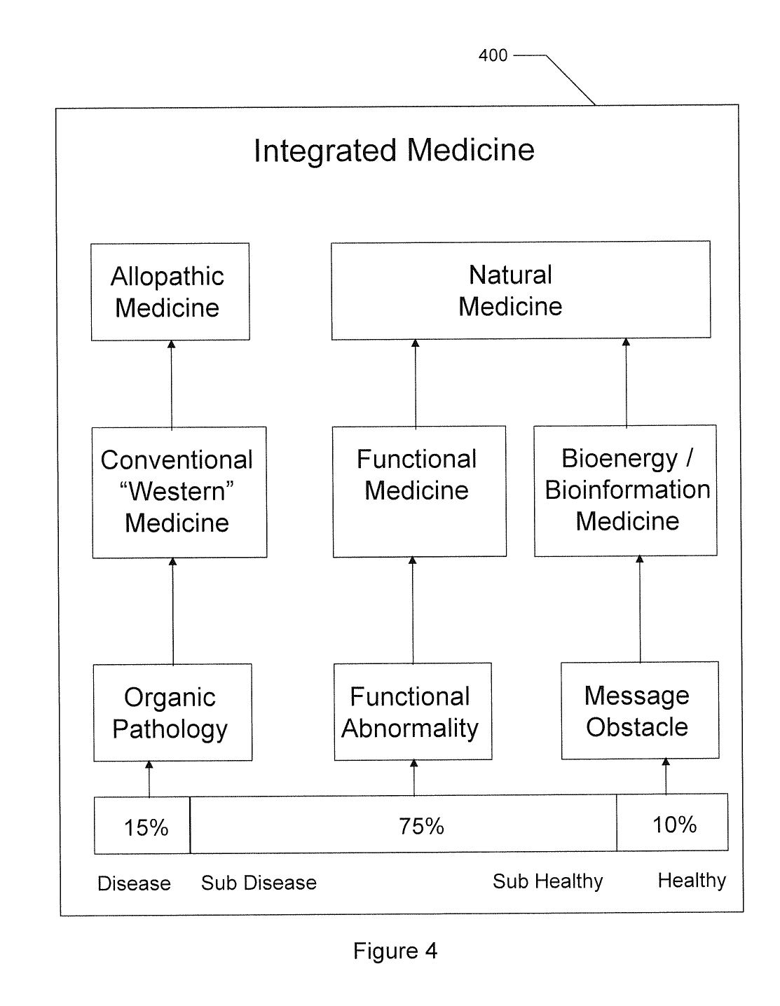

Refer to FIG. 4. The total heath services provider of the present invention comprises integrated medicine 400. In FIG. 4, health status percentages are illustrated on a line from “Disease” for a health status where the patient has been diagnosed with a disease to “Healthy”. For example, if 100 patients are examined, 15% are diagnosed in the Disease category, 10% are diagnosed in the Healthy category, and 75% are diagnosed between the Disease category and the Healthy category. This 75% range from a Sub Disease category to a Sub Healthy category.

Conventional western medicine diagnoses a patient in the Disease category and the disease is determined by organic pathology by testing bodily organs or physiology. Treatment of the disease by conventional western medicine uses a system of medical practice that aims to combat disease by use of remedies, such as drugs or surgery. This system of medicine is defined as allopathic medicine.

Bio-energy/Bio-information medicine diagnoses a patient in the Healthy category by observing message obstacles. Bio-energy/Bio-information medicine utilizes health promotion treatments of natural medicine to improve or maintain the patient's health.

Conventional medicine can effectively diagnose and treat patients in the Disease category. However, diagnosis/evaluation and treatment/adjustment of individuals in the Healthy, Sub Healthy, and Sub Disease categories can be difficult since conventional medicine cannot detect the health status of the individuals in these three categories.

To accurately evaluate the health status of individuals in the Sub Disease and Sub Healthy categories, functional medicine observes functional abnormality. Functional medicine uses natural medicine for treating observed inadequacies in a patient to improve the patient's health.

The integrated medicine 400 of the total health services provider of the present invention utilizes western medicine, natural medicine, Chinese medicine, functional medicine, and bio-energy/bio-information medicine to assess health and provide treatments.

The present invention provides disease prevention and health promotion, starting with therapeutic, prophylactic, anti-aging and rejuvenation to establish an integrated medical health service system. With the most advanced medical technology, ideas, products, pathways and networks, the present invention introduces advanced types of health care to provide comprehensive physical and mental health assessment using the methods of empirical science, health conditioning and health promotion services and management, maintenance, holistic for all people's health.

The total health services provider of the present invention uses distinctive equipment, methods, such as high-powered blood morphology examination, iridology examination, 3D MRA, meridian detection, heart rate variability measurement, neurological testing, functional medicine and biochemical testing, spinal structural evaluation, etc.

By providing an integrated medicine health facility, including remote health checks and monitoring, providing the sale of health care products to patients and customers, and receiving referrals from medical professionals that are unable to provide the wide variety of integrated medicine services, the total health services provider is not only profitable when a patient is sick (medication, injections, surgery, etc.) but also when an individual is healthy (nutritional supplements, exercise plans, or other health care products). Moreover, the total health services provider provides disease prevention, combats aging, and promotes health and rejuvenation thereby improving the physical and mental health of patients and individuals.

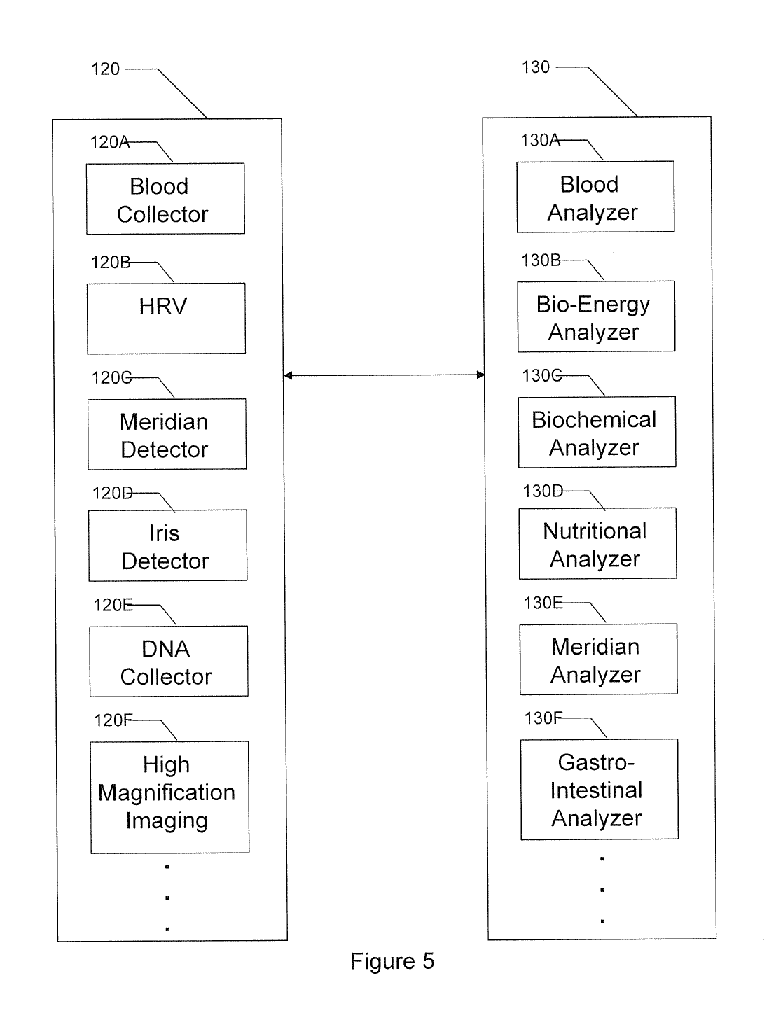

Refer to FIG. 5. The data collection tools 120 comprise a plurality of integrated medicine data collection tools 120A-120F for collecting and inspecting a wide variety of data from patients. The plurality of integrated medicine data collection tools 120A-120F comprises, for example, blood collecting tools and devices 120A for extracting blood samples from a patient, Heart Rate Variability (HRV) tools 120B for detecting autonomic nerve function of a patient, meridian detector tools 120C for inspecting acupressure and meridian points of a patient, Iris detector tools 120D for inspecting iris texture, color, spots, rings, cracks, or pits, DNA collector tools 120E for obtaining samples of a patient's DNA, High Magnification Imaging Tools 120F for optical amplification to collect data of a patient's nutritional status, uric acid metabolism, immunity, and cardiovascular circulation, 3D MRA tools for non-invasive detection of internal conditions using magnetic resonance signals, and other patient data collecting tools.

The patient data collected by the plurality of data collection tools 120 is transferred to a plurality of analysis tools 130. The plurality of analysis tools 130 analyzes appropriate patent data according to the particular analysis tool. The plurality of analysis tools 130 comprises, for example, a blood analyzer 130A, a bio-energy analyzer 130B, a biochemical analyzer 130C, a nutritional analyzer 130D, a meridian analyzer 130E, and a gastrointestinal analyzer 130F, and other analyzing tools.

The data collection tools 120 and the analysis tools 130 cooperate to identify a patient's health by performing biochemical analysis of for example, blood, urine, liver and gall bladder function, nutrition, cholesterol, electrolytes, cardiac function, cancer screening, amino acid balance, metabolism, gastrointestinal system, flora balance, protein, pylori antigen, adrenal stress, hormone, immune function, food allergen, detoxification function, cardiovascular system, brain degeneration risk factor, trace element balance, thyroid hormone, bone loss, hypertension, diabetes, obesity, stress, depression, anxiety, osteoporosis, aging, asthma, etc.

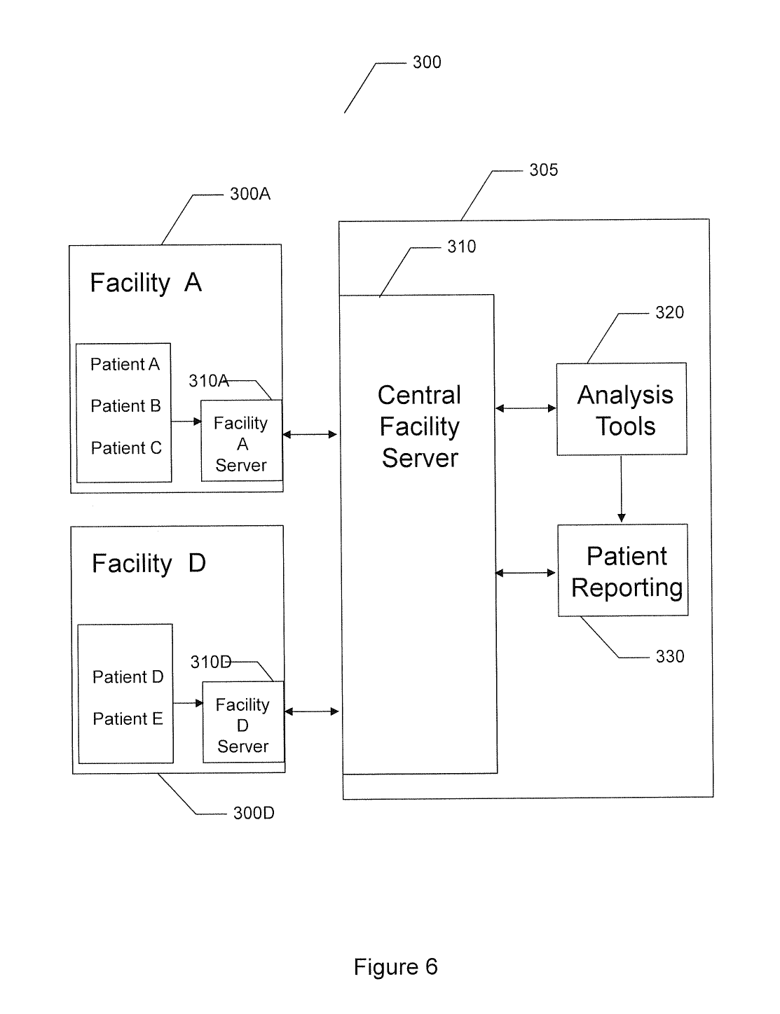

Refer to FIG. 6. In embodiments of the present invention the total health services provider 300 is expandable by adding additional medical facilities in areas remote from the central medical facility.

The total health services provider 300 of the present invention illustrated in FIG. 6 comprises a central facility 305 comprising a central facility server 310, and a plurality of medical facilities 300A-300D. Facility A 300A provides services to a plurality of patients (Patient A, Patient B, Patient C) and collects patient data from these patients. The collected patient data is sent by Facility A server 310A to the central facility server 310. Similarly, Facility D 300D collects patient data from Patient D and Patient E and sends the collected data from the Facility D server 310D to the central facility server 310.

When the central facility server 310 receives patient data from any of the remote facility servers (310A, 310D), the central facility server 310 provides the patient data to the appropriate analysis tools 320 for analysis. After the analysis tools 320 have completed the analysis, the patient reporting 330 creates individualized patient reports from the analysis results. Additionally, suggested health adjustment procedures are included in the patient reports. The central facility server 310 sends the patient reports to the appropriate facility server and the patient report is provided to the appropriate patient. Based on the analysis results and the patient reports with suggested health adjustment procedures, appropriate health adjustment procedures or techniques are performed with the patient.

The central facility server 310 and all of the facility servers 310A, 310D comprise at least one microprocessor for executing processes and at least one non-transitory memory for storing data.

The expandable health services provider 300 of the present invention provides numerous advantages. The cost of establishing the medical facilities is much lower than conventional facilities since analysis medical personnel and analysis tools are provided by the central medical facility rather than each medical facility. Training and quality of service are easier to control and uniform across medical facilities. Also, health services are provided to patients in locations where it would normally not be feasible to provide a medical facility.

Additionally, the present invention comprises advantages of lower cost, repeatable examinations, non-invasive procedures, rapid analysis and comprehensive results, and early interpretation of health status.

In an embodiment of the present invention the remote medical facilities purchase health products and services from the central medical facility which provides additional revenue to the central medical facility.

In an embodiment of the present invention the remote medical facilities pay franchise fees to the central medical facility.

Since the central medical facility provides training, services, equipment, methods, and products to each of the remote medical facilities, the products and level of quality and service are consistent throughout the total health services provider network.

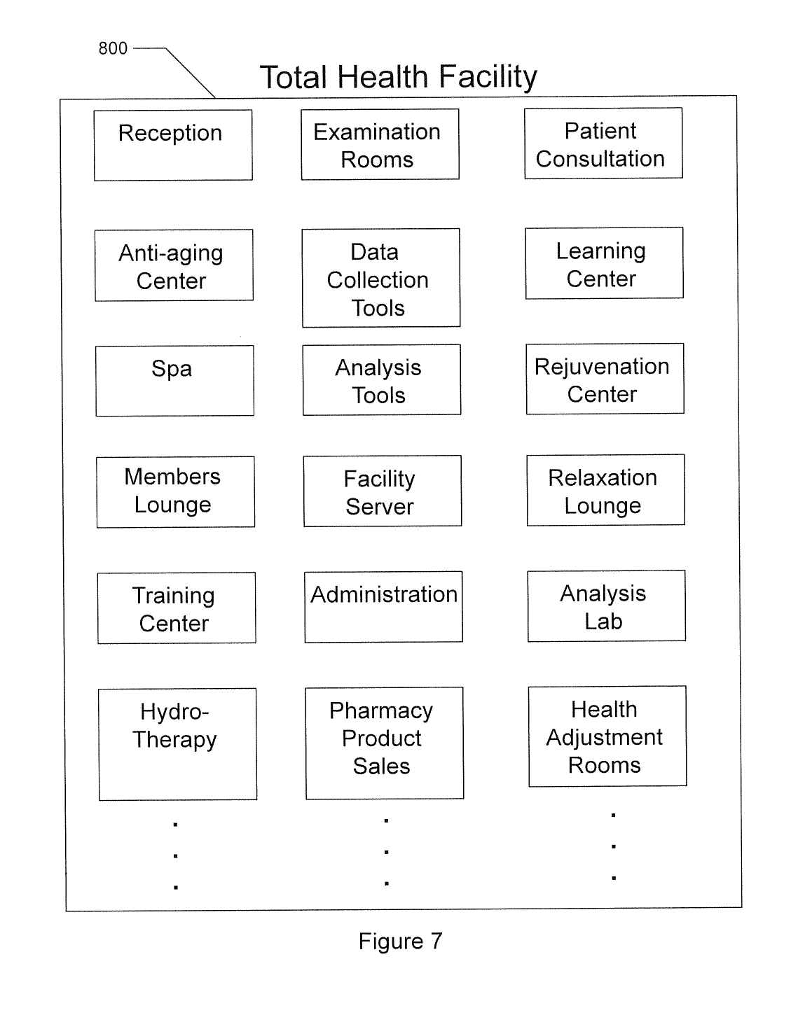

Refer to FIG. 7. The total health services provider comprises at least one total health facility 800. The total health facility 800 comprises a plurality of areas, rooms, centers, or labs to provide integrated medicine services. For example, the total health facility comprises a reception area from checking in patients, examination rooms, data collection tools, analysis tools, facility server, patient consultation, anti-aging center, learning center, spa, treatment rooms, members lounge for providing special services to members, relaxation lounge, training center for training medical personnel from remote medical facilities and the central facility, administration, analysis lab, hydrotherapy, pharmacy product sales, a rejuvenation center, a fitness center, a swimming pool, a restaurant for providing healthy cuisine to patients and the general public, a food market for providing healthy foods for purchase, and a yoga center.

The relaxation lounge provides a comfortable area for patients to relax in prior to or after their appointment. For example, patients relax by listening to soothing music and enjoying calming beverages in a peaceful environment. The relaxation lounge eliminates patient stress induced by conventional crowded waiting rooms. The learning center provides information such as literature or videos to increase a patient's or patient's companion health knowledge.

The members lounge provides an area restricted to only members of the total health network that have purchased a membership. The membership allows members to converse with other members and enjoy exclusive services provided to members.

The pharmacy product sales allows patients or customers to purchase health care products such as, for example, nutrition supplements, probiotics, enzyme drinks, aromatherapy products, organic food products, multimedia products for relaxation and exercise, etc.

An advantage of the total health facility of the present invention is that the facility can add or remove areas, centers, lounges, or rooms to adapt to the size of the facility, number of patients, or popularity of service.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A total health services provider comprising:
a server comprising a microprocessor and a non-transitory memory for storing a patient database and a total patient database;
a plurality of data collection tools for collecting patient data;
a plurality of analysis tools for analyzing the patient data and producing analysis results;
the patient database comprising the patient data and the analysis results;
a patient reporter for producing patient reports from the patient data and the analysis results;
a plurality of health adjustment methods for performing with patients based on the analysis results;
a plurality of total data analysis tools for analyzing anonymous patient data from a plurality of patients stored in the total patient database and producing total analysis results;
the total patient database comprising the anonymous patient data and the total analysis results; and
a study data reporter for producing study reports from the anonymous patient data and the total analysis results.

2. The total health services provider of claim I, the plurality of data collection tools comprising instruments, implements, devices, or other tools that extract, detect, monitor, or receive data from a patient.

3. The total health services provider of claim 1, the patient data comprising heart rate, heart rate variation, iris data, blood, blood data, acupressure data, meridian data, spinal structure evaluation data, or 3-dimensional magnetic resonance analysis data.

4. The total health services provider of claim 1, the plurality of data collection tools comprising:
blood collecting tools for extracting blood samples from a patient;
heart rate variability tools for detecting nervous energy of a patient;
meridian detector tools for inspecting acupressure and meridian points of a patient;
iris detector tools for inspecting iris texture, color, spots, rings, cracks, or pits; and
high magnification imaging tools for optical amplification to collect data of a patient's nutritional status, uric acid metabolism, immunity, and cardiovascular circulation.

5. The total health services provider of claim 1, the plurality of analysis tools comprising a blood analyzer, a bio-energy analyzer, a biochemical analyzer, a nutrition analyzer, a meridian analyzer, or a gastrointestinal analyzer.

6. The total health services provider of claim 1, the plurality of data collection tools and the plurality of analysis tools cooperating to identify a patient's health by performing biochemical analysis of blood, urine, liver and gall bladder function, nutrition, cholesterol, electrolytes, cardiac function, cancer screening, amino acid balance, metabolism, gastrointestinal system, flora balance, protein, pylori antigen, adrenal stress, hormone, immune function, food allergen, detoxification function, cardiovascular system, brain degeneration risk factor, trace element balance, thyroid hormone, bone loss, hypertension, diabetes, obesity, stress, depression, anxiety, osteoporosis, aging, or asthma.

7. The total health services provider of claim 1, the plurality of analysis tools comprising at least one conventional western medicine analyzer, at least one functional medicine analyzer, at least one bio-energy/bio-information medicine analyzer, and at least one natural medicine analyzer.

8. The total health services provider of claim 1, the patient reports comprising patient data and analysis results displayed as text and as visual diagrams, and the patient reports are provided to appropriate patients.

9. The total health services provider of claim 1, further comprising:
a medical facility located remotely from the server, the medical facility collecting patient data and sending the patient data via a facility server to the server, and the server sending patient reports after analyzing the patient data to the facility server of the medical facility.

10. A total health services provider method comprising:
checking in a patient when a patient arrives at a medical facility;
collecting patient data from the patient using a data collection tool;
analyzing the patient data using an analysis tool to obtain analysis results;
storing the patient data and the analysis data in a patient database on a server;
creating patient reports from the patient data and the analysis results;
providing the patient reports to the patient;
performing a health adjustment procedure with the patient;
removing the identity of the patient from the patient data to produce anonymous patient data;
storing the anonymous patient data in a total patient database;
analyzing the anonymous patient data and other anonymous patient data from other patients in the total patient database to obtain total patient analysis results;
storing the total patient analysis results in the total patient database; and
creating study data reports from the total patient analysis results and anonymous patient data.

11. The total health services provider method of claim 10, further comprising:
sending the patient data to a central facility for analysis; and
receiving the patient reports from the central facility.

12. A total health services provider comprising:
a central facility comprising;
a server comprising a microprocessor and anon-transitory memory for storing a patient database and a total patient database;
a plurality of integrated medicine analysis tools for analyzing patient data and producing analysis results;
the patient database comprising the patient data and the analysis results;
a patient reporter for producing patient reports from the patient data and the analysis results;
a plurality of total data integrated medicine analysis tools for analyzing anonymous patient data from a plurality of patients stored in the total patient database and producing total analysis results;
the total patient database comprising the anonymous patient data and the total analysis results; and
a study data reporter for producing study reports from the anonymous patient data and the total analysis results; and
a plurality of facilities located remotely from the central facility, each facility comprising:
a plurality of integrated medicine data collection tools for collecting the patient data; and
a facility server for sending the patient data to the central facility server for analyzing and for receiving the patient reports after analysis of the patient data from the central facility server.

13. The total health services provider of claim 12, the plurality of facilities purchasing health products and services from the central facility.

14. The total health services provider of claim 12, the plurality of facilities paying franchise fees to the central facility.

15. The total health services provider of claim 12, the plurality of integrated medicine data collection tools comprising instruments, implements, devices, or other tools that extract, detect, monitor, or receive data from a patient.

16. The total health services provider of claim 12, the plurality of integrated medicine data collection tools comprising:
blood collecting tools for extracting blood samples from a patient;
heart rate variability tools for detecting nervous energy of a patient;
meridian detector tools for inspecting acupressure and meridian points of a patient;
iris detector tools for inspecting iris texture, color, spots, rings, cracks, or pits; and
high magnification imaging tools for optical amplification to collect data of a patient's nutritional status, uric acid metabolism, immunity, and cardiovascular circulation.

17. The total health services provider of claim 12, the plurality of integrated medicine analysis tools comprising a blood analyzer, a bio-energy analyzer, a biochemical analyzer, a nutritional analyzer, a meridian analyzer, or a gastrointestinal analyzer.

18. The total health services provider of claim 12, the plurality of integrated medicine data collection tools and the plurality of integrated medicine analysis tools cooperating to identify a patient's health by performing biochemical analysis of blood, urine, liver and gall bladder function, nutrition, cholesterol, electrolytes, cardiac function, cancer screening, amino acid balance, metabolism, gastrointestinal system, flora balance, protein, pylori antigen, adrenal stress, hormone, immune function, food allergen, detoxification function, cardiovascular system, brain degeneration risk factor, trace element balance, thyroid hormone, bone loss, hypertension, diabetes, obesity, stress, depression, anxiety, osteoporosis, aging, or asthma.

19. The total health services provider of claim 12, the plurality of integrated medicine analysis tools comprising at least one conventional western medicine analyzer, at least one functional medicine analyzer, at least one bio-energy/bio-information medicine analyzer, and at least one natural medicine analyzer.

20. The total health services provider of claim 12, the patient reports comprising patient data and analysis results displayed as text and as visual diagrams, and the patient reports are provided to appropriate patients.
